(19) United States
(12) Patent Application Publication
(10) Pub. No.: US 2025/0133386 A1
(43) Pub. Date: Apr. 24, 2025

(54) MOBILE PLAN ADD-ON FOR ELECTRONIC DEVICES

(71) Applicant: Samsung Electronics Co., Ltd., Suwon-si (KR)

(72) Inventors: Swetal Patel, Monroe Township, NJ (US); Rajeshkumar Somasekhar, Skillman, NJ (US)

(21) Appl. No.: 18/610,853

(22) Filed: Mar. 20, 2024

Related U.S. Application Data
(60) Provisional application No. 63/544,769, filed on Oct. 18, 2023.

(51) Int. Cl. H04W 8/18; G06K 19/06; H04L 67/55

(52) U.S. Cl. CPC H04W 8/18; G06K 19/06037; H04L 67/55

(57) ABSTRACT

A method includes obtaining, using at least one processing device of an electronic device, input identifying a specified service offered by a mobile network operator that is not currently part of a service plan associated with the electronic device. The method also includes generating, using the at least one processing device, a subscription message for the mobile network operator, where the subscription message requests the specified service from the mobile network operator. The method further includes initiating, using the at least one processing device, transmission of the subscription message to the mobile network operator. In addition, the method includes obtaining, using the at least one processing device, a response to the subscription message, where the response indicates that the electronic device has been subscribed to the specified service.

### CROSS-REFERENCE TO RELATED APPLICATION AND PRIORITY CLAIM

This application claims priority under 35 U.S.C. § 119 (e) to U.S. Provisional Patent Application No. 63/544,769 filed on Oct. 18, 2023, which is hereby incorporated by reference in its entirety.

### TECHNICAL FIELD

This disclosure relates generally to communication systems and methods. More specifically, this disclosure relates to mobile plan add-on for electronic devices.

### BACKGROUND

The introduction of 5G network features and other advanced network features in wireless cellular communication networks is opening doors for various use cases and opportunities for mobile network operators. However, due to the costs of 5G or other network infrastructures, providing full capabilities for end users tends to be very high. That is, while 5G and other networks can be flexibly used to provide a number of different services to users, actually bringing those features to the users can be difficult.

### SUMMARY

This disclosure relates to mobile plan add-on for electronic devices.

In a first embodiment, a method includes obtaining, using at least one processing device of an electronic device, input identifying a specified service offered by a mobile network operator that is not currently part of a service plan associated with the electronic device. The method also includes generating, using the at least one processing device, a subscription message for the mobile network operator, where the subscription message requests the specified service from the mobile network operator. The method further includes initiating, using the at least one processing device, transmission of the subscription message to the mobile network operator. In addition, the method includes obtaining, using the at least one processing device, a response to the subscription message, where the response indicates that the electronic device has been subscribed to the specified service.

In a second embodiment, an electronic device includes at least one processing device configured to obtain input identifying a specified service offered by a mobile network operator that is not currently part of a service plan associated with the electronic device. The at least one processing device is also configured to generate a subscription message for the mobile network operator, where the subscription message requests the specified service from the mobile network operator. The at least one processing device is further configured to initiate transmission of the subscription message to the mobile network operator. In addition, the at least one processing device is configured to obtain a response to the subscription message, where the response indicates that the electronic device has been subscribed to the specified service.

In a third embodiment, a non-transitory machine-readable medium contains instructions that when executed cause at least one processor of an electronic device to obtain input identifying a specified service offered by a mobile network operator that is not currently part of a service plan associated with the electronic device. The non-transitory machine-readable medium also contains instructions that when executed cause the at least one processor to generate a subscription message for the mobile network operator, where the subscription message requests the specified service from the mobile network operator. The non-transitory machine-readable medium further contains instructions that when executed cause the at least one processor to initiate transmission of the subscription message to the mobile network operator. In addition, the non-transitory machine-readable medium contains instructions that when executed cause the at least one processor to obtain a response to the subscription message, where the response indicates that the electronic device has been subscribed to the specified service.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory, computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example of a network configuration including an electronic device in accordance with this disclosure;

FIG. 2 illustrates an example communication system supporting mobile plan add-on for electronic devices in accordance with this disclosure;

FIGS. 3 and 4 illustrate an example technique for mobile plan add-on using vendor tickets in accordance with this disclosure;

FIGS. 5 and 6 illustrate an example technique for mobile plan add-on using push notifications in accordance with this disclosure; and

FIGS. 7 through 9 illustrate example methods for mobile plan add-on in accordance with this disclosure.

### DETAILED DESCRIPTION

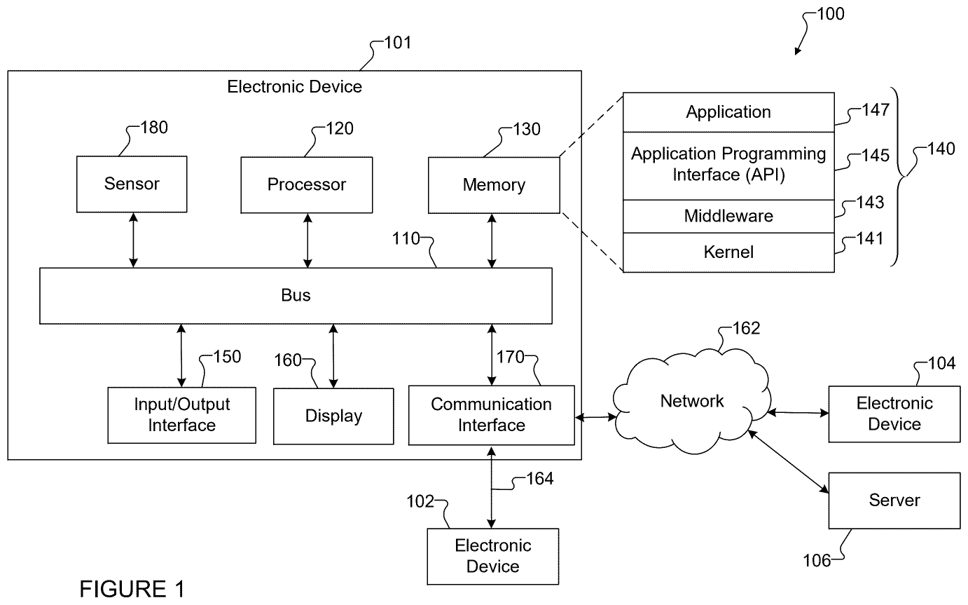

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, the introduction of 5G network features and other advanced network features in wireless cellular communication networks is opening doors for various use cases and opportunities for mobile network operators. However, due to the costs of 5G or other network infrastructures, providing full capabilities for end users tends to be very high. That is, while 5G and other networks can be flexibly used to provide a number of different services to users, actually bringing those features to the users can be difficult.

As an example of this, adding custom or on-demand services to end users' existing cellular subscriptions remains a cumbersome and inconvenient process for the users. Often times, a user is required to call a mobile network operator's customer service representative to add a service to his or her cellular subscription. The added service generally remains on the user's cellular subscription until the user calls a mobile network operator's customer service representative again to remove the service from his or her cellular subscription. Alternatively, a user may need to actively log into a user account associated with his or her cellular subscription in order to view service plans and make changes, and the user typically needs to repeat this process in order to change back or make another change to his or her service plan.

This disclosure provides various techniques for mobile plan add-on for electronic devices. As described in more detail below, input identifying a specified service offered by a mobile network operator that is not currently part of a service plan associated with the electronic device can be obtained. For example, obtaining the input may include scanning and decoding an optical code (such as a QR code) to identify the mobile network operator and the specified service. As a particular example, the optical code may be printed on an event ticket (such as a ticket for a concert or sporting event). As another example, obtaining the input may include receiving a push notification indicating that the mobile network operator is offering one or more services, and a user may interact with his or her electronic device to identify the specified service. A subscription message can be generated for the mobile network operator, where the subscription message requests the specified service from the mobile network operator, and transmission of the subscription message to the mobile network operator can be initiated. A response to the subscription message can be obtained, where the response indicates that the electronic device has been subscribed to the specified service. In some cases, requests and responses can be used that comply with the GSM Association (GSMA) TS.43 application programming interface (API) specification.

In this way, the described techniques allow for users to add subscriptions to cellular-based services in a simpler and more convenient manner. Note that any suitable services may be offered to users using the described techniques. For example, users may be offered video, audio, or data communication services having decreased network latency or increased network bandwidth, or users may be offered guaranteed network latency or guaranteed network bandwidth. A subscription offer can be for all applications executed by a user's electronic device or only for one or more specified applications. As another example, users may be offered the ability to add a roaming feature to a service plan. Depending on the implementation, a change to a user's service plan may be permanent or temporary, such as when a temporary change results in reverting back to the user's original service plan after a specified event has ended or after a specified time period has elapsed.

Note that while some of the embodiments discussed below are described in the context of use in specific types of consumer electronic devices (such as smartphones), this is merely one example. It will be understood that the principles of this disclosure may be implemented in any number of other suitable contexts and may use any suitable device or devices. Also, note that while certain communication standards may be mentioned below, this is for illustration and explanation only and does not limit the scope of this disclosure. In general, this disclosure is not limited to use with any specific type(s) of device(s) or any specific communication standard(s).

FIG. 1 illustrates an example of a network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may be used to provide mobile plan add-on, such as by interacting with one or more servers 106 or other components to temporarily or permanently add one or more services to a service plan associated with the electronic device 101.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications for mobile plan add-on. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals, such as images.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head-mounted device (HMD)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may be used to provide mobile plan add-on, such as by interacting with the electronic device 101 and one or more other servers 106 or other components to temporarily or permanently add one or more services to a service plan associated with the electronic device 101.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

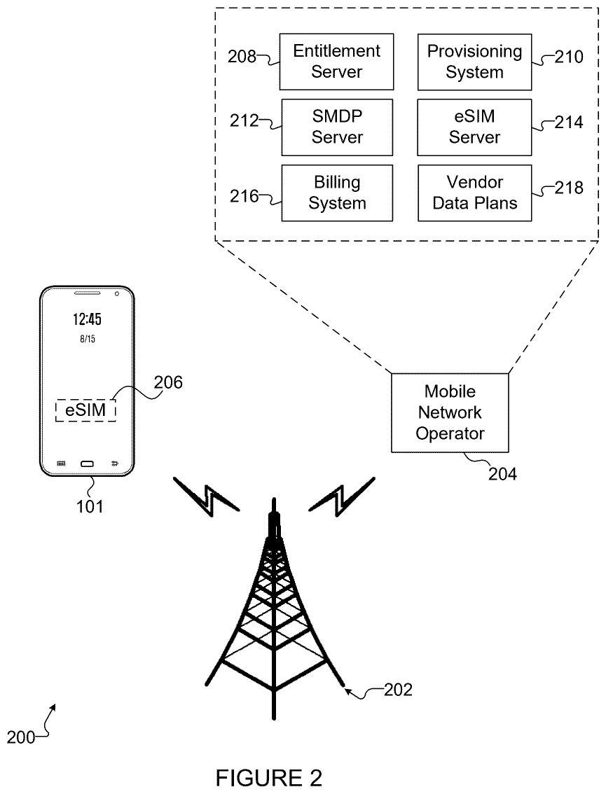

FIG. 2 illustrates an example communication system 200 supporting mobile plan add-on for electronic devices in accordance with this disclosure. For ease of explanation, the system 200 shown in FIG. 2 is described as being used by or with the electronic device 101 from the network configuration 100 of FIG. 1. However, the system 200 shown in FIG. 2 could be used with any other suitable electronic device(s) and in any other suitable system(s).

As shown in FIG. 2, the system 200 includes the electronic device 101, one or more base stations 202, and at least one mobile network operator (MNO) 204. The electronic device 101 is configured to communicate through the base station(s) 202 with at least one MNO 204 and to receive service from the at least one MNO 204. Depending on the circumstances, the electronic device 101 may receive service from one MNO 204 or from multiple MNOs 204. In some embodiments, the electronic device 101 is configured to use at least one electronic subscriber identity module (eSIM) 206, each of which may be independently configured to attach to a particular MNO 204. For example, if the electronic device 101 includes three eSIMs 206, the eSIMs 206 may be configured to attach to three different MNOs 204, such as in order to receive service from the different MNOs 204. Note that while the base station 202 is shown here as being separate from the MNO 204, base stations 202 are often said to represent a radio access network (RAN) of each MNO 204.

Each MNO 204 generally includes various components used to provide services to the electronic device 101 and other devices. For example, each MNO 204 may include a GSMA TS.43 API-based entitlement server 208 that can receive requests from and provide responses to the electronic device 101 and other devices. Each MNO 204 may include a provisioning system 210 that can be used to provision eSIMs for the electronic device 101 and other devices, and each MNO 204 may include a subscription manager data preparation (SMDP) server 212 that is used to process information from the provisioning system 210 to generate personalized eSIMs for the electronic device 101 and other devices. The personalized eSIMs may be stored and provided to the electronic device 101 and other devices using an eSIM server 214 of the corresponding MNO 204. Each MNO 204 typically includes a billing system 216 that can be used to invoice customers of the MNO 204 and determine if certain services are pre-paid and therefore not billable to the customers of the MNO 204. Each MNO 204 may include a vendor data plans server 218 that allows vendors or other third-parties to offer pre-paid services or other services through the MNO 204. In some cases, each one of these components may be implemented using one or more servers, such as one or more servers 106.

Although FIG. 2 illustrates one example of a system 200 supporting mobile plan add-on for electronic devices, various changes may be made to FIG. 2. For example, the system 200 of FIG. 2 has been simplified for ease of illustration and explanation. Cellular and other communication networks are often highly complex and involve numerous components, which are often spread out over a wide geographical area.

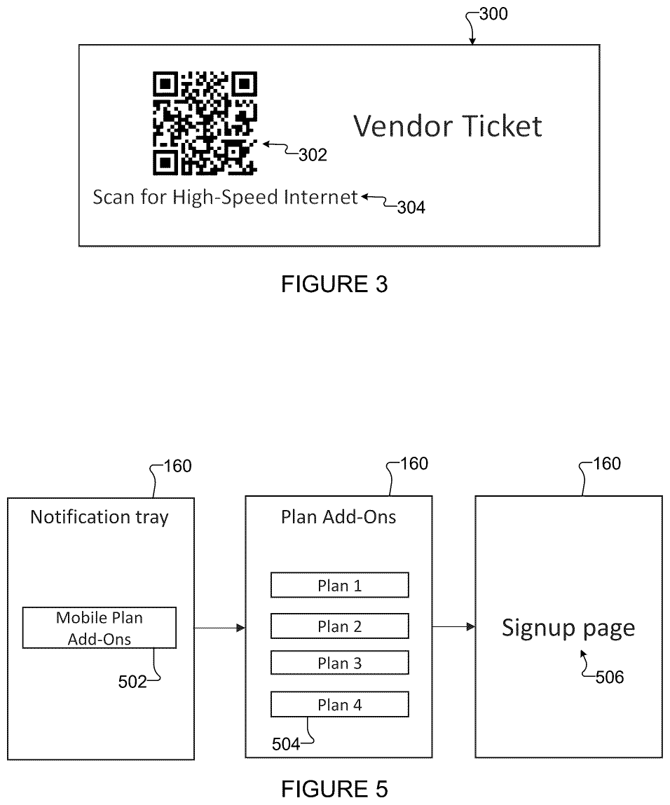

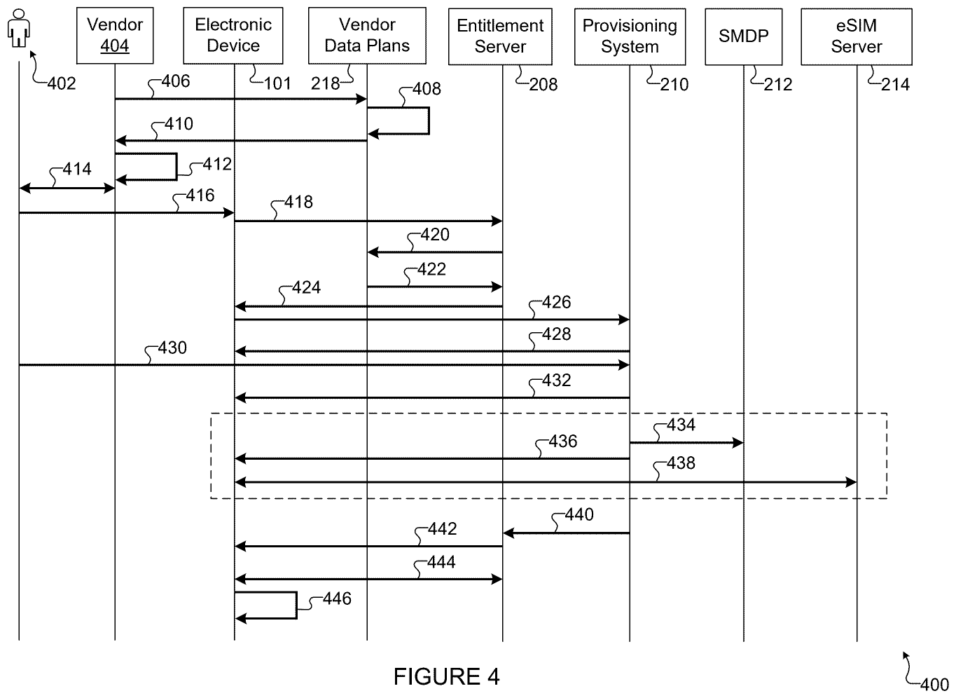

FIGS. 3 and 4 illustrate an example technique for mobile plan add-on using vendor tickets in accordance with this disclosure. For ease of explanation, the technique shown in FIGS. 3 and 4 is described as involving the use of the electronic device 101 shown in FIG. 1 within the system 200 shown in FIG. 2. However, the technique shown in FIGS. 3 and 4 may involve the use of any other suitable device(s) and any other suitable system(s).

As shown in FIG. 3, a vendor ticket 300 is illustrated for an unspecified event. The vendor ticket 300 may represent a ticket for any suitable event, such as a sporting event, music event, school graduation, or other event where cellular networks are usually congested. In this example, the vendor ticket 300 includes an optical code 302, which represents an optical encoding of information related to a particular communication service 304 being offered to the ticketholder. The optical code 302 may represent any suitable optical-based encoding of information on a vendor ticket 300. In this example, the optical code 302 represents a QR code, although a one-dimensional barcode or other optical code may be used. A user may use his or her electronic device 101 to decode the information contained in the optical code 302 included in his or her vendor ticket 300 in order to access the communication service 304.

Note that the vendor ticket 300 may be printed or electronic. In printed form, the user may use one or more imaging sensors 180 of his or her electronic device 101 in order to scan the optical code 302 in the printed vendor ticket, where the scanned information can be decoded. In digital form, the user may use a decoding function of his or her electronic device 101 in order to decode the optical code 302 in the digital vendor ticket. Also note that the communication service 304 being offered here may represent any suitable service, such as any of the various services discussed above regarding latency, bandwidth, guaranteed latency, guaranteed bandwidth, and roaming. In some cases, the communication service 304 being offered may represent a pre-paid service, such as a service that the user of the electronic device 101 needs to pay for prior to the event or a service that is included in the price of the vendor ticket 300. As a particular example, the optical code 302 may include or be associated with an offer for a pre-paid subscription for a service that is not currently tied to a user account associated with a user of the electronic device 101.

The optical code 302 may encode any suitable information related to the offering of the communication service 304. In some embodiments, the optical code 302 may have the format of “TS43:$MNOName$UpdateSubscription$VendorCouponCode”. Here, “TS43” represents an application name that can be triggered when the optical code 302 is scanned (a TS.43 client in this example), “MNOName” represents the name of the MNO 204 for which a subscription update will be made in order to obtain the service 304, “UpdateSubscription” represents a TS.43 on-device service activation (ODSA) flow action to be performed on the electronic device 101, and “VendorCouponCode” represents a coupon code that corresponds to a pre-paid subscription for the service 304. The “VendorCouponCode” parameter is not a standard field in the TS43.manageSubscription API of the entitlement server 208 and is added here to support the addition of a pre-paid service subscription to the user account associated with the electronic device 101. With this parameter, the electronic device 101 can pass the coupon code information to the MNO's TS.43 API-based entitlement server 208 so that features corresponding to the coupon code can be linked with the user's service plan. This may also allow the user to obtain a pre-paid subscription to a service so that the typical purchase flow can be bypassed and the requested service can be added to user's service plan.

As shown in FIG. 4, a timing diagram 400 illustrates a process flow for using vendor tickets 300. In FIG. 4, the process flow involves an electronic device 101, a user 402 of the electronic device 101, a vendor 404 (such as an event organizer) associated with an event, and various components of an MNO 204. The vendor 404 can initiate the process flow by submitting a request 406 for a service to the vendor data plans server 218, such as a request 406 related to a bulk purchase of a specified number of service subscriptions from the MNO 204. The vendor data plans server 218 of the MNO 204 generates optical codes for the vendor 404 during at least one operation 408 and provides the optical codes to the vendor 404 in one or more responses 410. In some cases, the one or more responses 410 may represent one or more TS43:updateSubscription:VendorCouponCode messages. The coupon codes can be linked to the requested service so that the requested service can be added to any existing subscription of a user account currently with the MNO 204 or used as a short-term subscription for a new subscriber. The vendor 404 inserts the optical codes into vendor tickets 300 as optical codes 302 during at least one operation 412.

The user 402 can purchase at least one ticket during a transaction 414. The user 402 can scan an optical code 302 of a ticket during an operation 416 using his or her electronic device 101, which initiates the process of actually subscribing to the service 304 on the ticket 300. The electronic device 101 sends a request 418 to the entitlement server 208, which represents a subscription message that in some cases may invoke a TS.43:manageSubscription API with updateSubscription and VendorCouponCode parameters. The entitlement server 208 sends a request 420 to the vendor data plans server 218, such as a request for information (like a request based on the VendorCouponCode) and may represent a FetchSubscription(VendorCouponCode) request in some cases.

The vendor data plans server 218 provides a response 422 containing service-related information, such as a uniform resource locator (URL) associated with the requested service and user data associated with the requested service. The entitlement server 208 provides a response 424 containing the same information to the electronic device 101. The electronic device 101 sends a request 426 containing the same information to the provisioning system 210, and the provisioning system 210 provides a response 428 identifying a web portal. A webpage associated with the web portal contains terms and conditions associated with the requested service and can be presented on the electronic device 101. The user 402 can trigger an acceptance 430 of the terms and conditions, which causes the provisioning system 210 to send an instruction 432 to dismiss the web portal on the electronic device 101.

When the electronic device 101 is associated with a user who has a user account with the MNO 204, the process based on the subscription message (request 418) causes the MNO 204 to associate the specified service with the user account associated with the electronic device 101. When the electronic device 101 is associated with a user who does not have a user account with the MNO 204, the provisioning system 210 sends a request 434 to the SMDP server 212 to create a new eSIM for the electronic device 101. The provisioning system 210 provides profile information 436 related to the new eSIM to the electronic device 101, and the electronic device 101 and the eSIM server 214 can interact during one or more operations 438 to download the new eSIM 206 to the electronic device 101. The new eSIM 206 allows the electronic device 101 to access the network of the MNO 204 and receive the requested service from the MNO 204.

The provisioning system 210 provides a notification 440 indicating a change in the service plan for the electronic device 101 to the entitlement server 208, and the entitlement server 208 provides a notification 442 indicating the change in the service plan to the electronic device 101. The electronic device 101 and the entitlement server 208 interact during at least one operation 444 to obtain information needed for the electronic device 101 to receive the requested service. In some cases, knowledge of the requested service may be used by one or more applications of the electronic device 101 to alter how the one or more applications behave. Here, the electronic device 101 may perform at least one operation 446 to notify one or more applications of the availability of the requested service. For example, this may include notifying one or more applications about the availability of unmetered mobile data so that the one or more applications may modify their operation, such as when one or more streaming applications can enable high-definition streaming on a cellular network.

Although FIGS. 3 and 4 illustrate one example of a technique for mobile plan add-on using vendor tickets, various changes may be made to FIGS. 3 and 4. For example, the form, contents, and layout of the vendor ticket 300 can easily vary depending on the circumstances. Also, while FIG. 4 illustrates various signaling between components, any desired subset of the signaling may be used or additional signaling may be used. As a particular example, there may be no need to notify any applications of the electronic device 101 about the requested service being available.

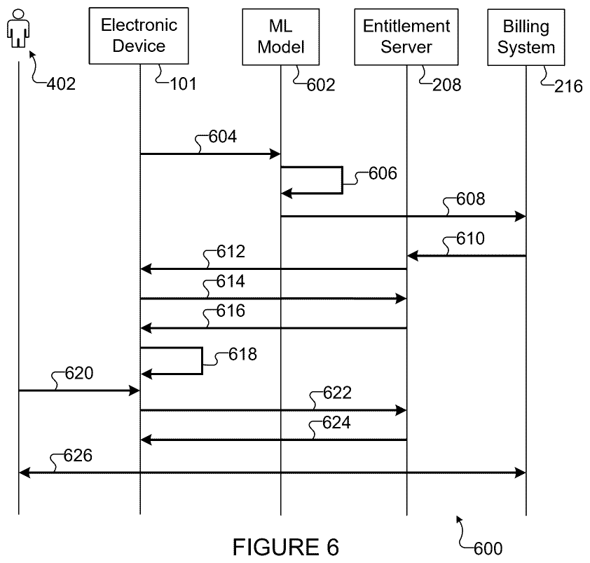

FIGS. 5 and 6 illustrate an example technique for mobile plan add-on using push notifications in accordance with this disclosure. For ease of explanation, the technique shown in FIGS. 5 and 6 is described as involving the use of the electronic device 101 shown in FIG. 1 within the system 200 shown in FIG. 2. However, the technique shown in FIGS. 5 and 6 may involve the use of any other suitable device(s) and any other suitable system(s).

As shown in FIG. 5, the electronic device 101 may receive a push notification 502 that is presented on the display 160 of the electronic device 101. The push notification 502 can indicate that an MNO 204 providing service to the electronic device 101 would like to provide one or more offers for one or more additional services to the electronic device 101. If the user accepts and selects the push notification 502, the display 160 can present a list of options 504, such as one or more options associated with one or more services offered by the MNO 204 that are not currently part of the service plan associated with the electronic device 101. If the user selects one of the options 504, the electronic device 101 can be redirected to display a signup page 506 for the selected service, such as a web portal for the selected service.

This approach allows push notifications to end users' electronic devices as needed or desired, such as whenever new promotional services are introduced by MNOs 204. The push notifications can be used here to initiate GSMA TS.43 API calls or other messages to acquire potential services for add-on to the users' current service plans. As a result, users are able to take action and obtain additional services, in some cases using standard APIs defined in the GSMA TS.43 API specification or other communication standard, in just a few clicks.

As shown in FIG. 6, a timing diagram 600 illustrates a process flow for using push notifications 502. In FIG. 6, the process flow involves an electronic device 101, a user 402 of the electronic device 101, various components of an MNO 204, and a trained machine learning (ML) model 602. The machine learning model 602 represents an optional component that may be used to process user- or device-related data in order to determine whether one or more particular users may be interested in potential offers for services. The machine learning model 602 may represent any suitable machine learning architecture that has been trained to identify potential services in which one or more users may be interested. The machine learning model 602 may also be trained in any suitable manner. In some cases, the machine learning model 602 may be trained using training data that includes various information about users and their electronic devices 101, such as specific characteristics of the users and their electronic devices 101, when users have used certain services, and which offers for services have and have not been accepted by users in the past. Note that the machine learning model 602 may be located in a user's electronic device 101, in a server or other device of an MNO 204, or in any other suitable location.

In this example, the electronic device 101 can provide information 604 to the machine learning model 602, such as characteristics of the user 402 or the electronic device 101. Example characteristics could include current bandwidth available to the electronic device 101, whether the electronic device 101 is experiencing network congestion, prior use of the electronic device 101, prior services that have or have not been offered to the user 402 or accepted by the user 402, or calendar entries for the user 402. This type of information may be used to determine if the user 402 of the electronic device 101 might be interested in temporarily or permanently increasing bandwidth or reducing latency or if the user 402 of the electronic device 101 is going to be traveling or attending an event where mobile hotspot or roaming might be of interest. The machine learning model 602 processes the information 604 during at least one operation 606 in order to identify one or more potential services in which the user 402 might be interested. The machine learning model 602 can send one or more messages 608 identifying the one or more potential services to the billing system 216.

The billing system 216 sends a message 610 to the entitlement server 208 indicating to the entitlement server 208 that there are one or more potential services that could be offered to the user 402 of the electronic device 101. The entitlement server 208 sends a push notification 612 to the electronic device 101, such as a TS.43-based push notification or other push notification that is displayed to the user 402 in order to indicate that the one or more potential services are available. If the user 402 elects to view the one or more potential services, the electronic device 101 sends a request 614 to the entitlement server 208, such as a request for information (like a TS.43 API AcquirePlan request). The entitlement server 208 provides one or more responses 616 that identify the one or more potential services being offered to the user 402 of the electronic device 101. The one or more responses 616 may, for instance, include information like a plan identifier, plan name, and plan description for each service.

The electronic device 101 can present the one or more potential services to the user 402 during an operation 618, such as by displaying each service option and (if selected for viewing) a description of the service option. The user 402 can make a selection 620 of one of the displayed options if desired. This causes the electronic device 101 to send a request 622 to the entitlement server 208, which represents a subscription message that in some cases may invoke a TS.43: manageSubscription API with the plan identifier of the selected service. The entitlement server 208 sends a response 624 to the electronic device 101, which may include a URL associated with the requested service and user data associated with the requested service. The electronic device 101 can interact with the billing system 216 during one or more operations 626 to present the selected service's terms and conditions to the user 402 for acceptance and to complete a subscription to the selected service, which may occur using the URL of the selected service. In some cases, this may include presenting a webpage associated with a web portal containing the terms and conditions associated with the selected service, which can be accepted by the user 402. The one or more operations 626 can associate the selected service with the user's account so that the electronic device 101 can receive the selected service and the user 402 can be billed for the selected service.

Although FIGS. 5 and 6 illustrate one example of a technique for mobile plan add-on using push notifications, various changes may be made to FIGS. 5 and 6. For example, the form, contents, and layout of the information on the display 160 in FIG. 5 can easily vary depending on the circumstances. Also, while FIG. 6 illustrates various signaling between components, any desired subset of the signaling may be used or additional signaling may be used. In addition, the use of machine learning for identifying one or more potential services is optional, and the one or more potential services may be identified in any other suitable manner.

The described techniques for mobile plan add-on may find use in a number of potential use cases. The following now describes specific examples of use cases in which mobile plan add-on may be used. Note, however, that these use cases are non-limiting and that the described techniques for mobile plan add-on may be used in any other suitable manner.

A first example use case can involve a high-speed cellular data service, such as one that can be obtained by enabling a network slicing feature. This service may be useful, for example, while the user 402 is attending an event at a specific venue where cellular networks are typically congested. Using the described techniques, the user 402 is able to add a network slicing service that provides upgraded device throughput while the user 402 is attending the event. In some cases, throughput of the electronic device 101 can be upgraded for a specific window of time that includes the event.

A second example use case can involve a mobile hotspot throughput upgrade. Using the described techniques, a user 402 may request a high-speed mobile hotspot connection while the user 402 is on a business or personal trip. The user's electronic device 101 may receive the upgraded high-speed mobile hotspot connection for part or all of the trip. At the end of the travel window, the user 402 may be given the option to extend the window of the upgraded high-speed mobile hotspot connection service or upgrade his or her service plan to permanently include this service.

A third example use case can involve a premium video calling feature upgrade. A user 402 in a group or other video call may experience a drop in video calling quality, such as due to network congestion. Using the described techniques, the user 402 may be given the option of adding a premium video calling service. If the user 402 accepts, the associated MNO 204 can enable the service, and the user's video calling experience can be upgraded, such as to higher-definition video calling with improved throughput and reduced latency.

A fourth example use case can involve the machine learning model 602 determining that a user 402 has an upcoming business or personal international trip. Using the described techniques, prior to starting the trip, the user 402 may be given the option to add a data roaming service for a requested numbers of hours, days, weeks, or other period of time. During the trip, the user 402 can receive data service outside of the user's normal service area without incurring larger fees.

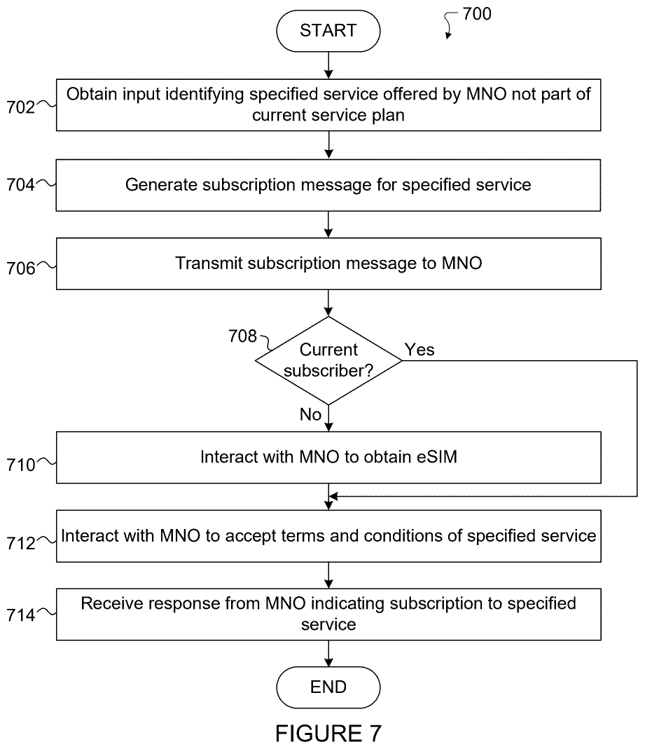

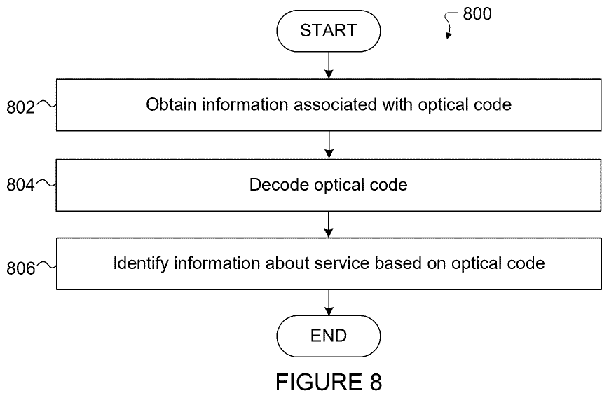

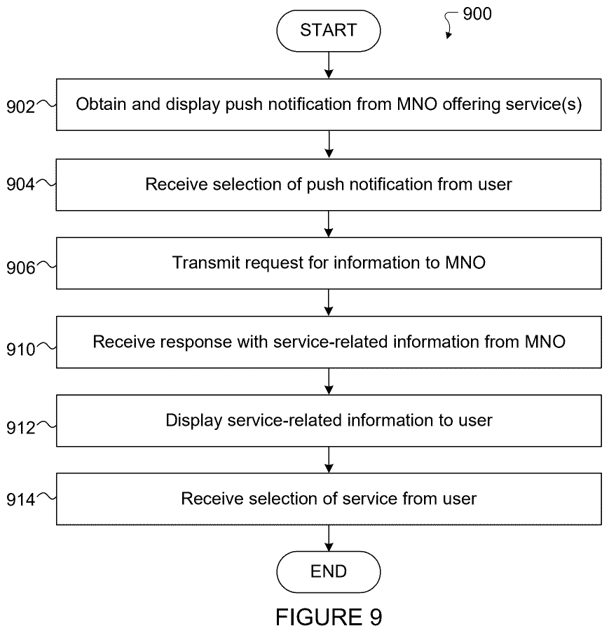

FIGS. 7 through 9 illustrate example methods for mobile plan add-on in accordance with this disclosure. More specifically, FIG. 7 illustrates an example method 700 for mobile plan add-on, and FIGS. 8 and 9 illustrate example techniques for identifying a service to be added. For ease of explanation, each method shown in FIGS. 7 through 9 is described as being performed by or with the electronic device 101 from the network configuration 100 of FIG. 1 in the system 200 of FIG. 2. However, each method shown in FIGS. 7 through 9 could be used with any other suitable electronic device(s) and in any other suitable system(s).

As shown in FIG. 7, input identifying a specified service offered by an MNO is obtained at step 702. This may include, for example, the processor 120 of the electronic device 101 obtaining information identifying a specific service from a specific MNO 204 to which a user 402 of the electronic device 101 wants to subscribe. Example techniques for obtaining the input are shown in FIGS. 8 and 9, which are described below. The specified service here can represent a service that is not part of the user's current service plan.

A subscription message for the specified service is generated at step 704 and transmitted to the MNO at step 706. This may include, for example, the processor 120 of the electronic device 101 generating a subscription message for the entitlement server 208, where the subscription message requests the specified service from the MNO 204. As a particular example, the subscription message may represent a TS.43:manageSubscription message containing updateSubscription and VendorCouponCode parameters or a plan identifier. This may also include the processor 120 of the electronic device 101 initiating transmission of the subscription message to the MNO 204, such as via a TS.43:manageSubscription API.

A determination is made whether the electronic device is associated with a current subscriber of the MNO (meaning a user 402 having a user account with an active service plan) at step 708. If not, the electronic device interacts with the MNO to obtain an eSIM for receiving the specified service from the MNO at step 710. This may include, for example, the processor 120 of the electronic device 101 interacting with the SMDP server 212 and the eSIM server 214 of the MNO 204 to obtain an eSIM 206. Note that if the electronic device 101 is associated with a current subscriber of the MNO 204, this may not be needed, and the subscription message can cause the MNO 204 to associate the specified service with the user account.

The electronic device interacts with the MNO to allow the user to accept terms and conditions of the specified service or otherwise complete signup for the specified service at step 712. This may include, for example, the processor 120 of the electronic device 101 interacting with the MNO 204 to receive a redirect to a web portal associated with the specified service, where the processor 120 of the electronic device 101 can initiate display of a webpage associated with the web portal. The webpage can include the terms and conditions of the specified service, and the processor 120 of the electronic device 101 can allow the user 402 of the electronic device 101 to accept the terms and conditions and thereby add the specified service to the user's service plan.

The electronic device obtains a response to the subscription message indicating that the electronic device has been subscribed to the specified service at step 714. This may include, for example, the processor 120 of the electronic device 101 interacting with the MNO 204 to receive information allowing the electronic device 101 to receive the specified service from the MNO 204.

As shown in FIG. 8, information associated with an optical code is obtained at step 802. This may include, for example, the processor 120 of the electronic device 101 receiving information about a scanned optical code 302 using at least one imaging sensor 180 of the electronic device 101. This may alternatively include the processor 120 of the electronic device 101 receiving information about a digital optical code 302. In some cases, the optical code 302 can represent a QR code. The optical code is decoded at step 804, and information about a specified service is obtained based on the decoded optical code at step 806. This may include, for example, the processor 120 of the electronic device 101 identifying information like an MNO name and a coupon code or other identifier associated with a specified service. The identified service can be used as input in step 702 of the method 700 described above.

As shown in FIG. 9, a push notification identifying one or more services being offered by an MNO is obtained and displayed at step 902. This may include, for example, the processor 120 of the electronic device 101 receiving a push notification 502 that is presented on the display 160 of the electronic device 101. The push notification 502 may provide an offering of one or more subscriptions to one or more services offered by an MNO 204 that are not currently part of the service plan associated with the electronic device 101. A selection or acceptance of the push notification is received at step 904. This may include, for example, the processor 120 of the electronic device 101 determining that the user 402 has selected the push notification 502 for viewing.

A request for information is transmitted to the MNO at step 906. This may include, for example, the processor 120 of the electronic device 101 sending a request to the MNO 204 for information about the one or more potential services being offered. A response to the request for information is received from the MNO, where the response includes service-related information, at step 908. This may include, for example, the processor 120 of the electronic device 101 receiving a response that includes an identifier, name, and description of each potential service being offered.

At least some of the service-related information is displayed to the user at step 910. This may include, for example, the processor 120 of the electronic device 101 generating and presenting a list of options 504 to the user, where the list of options 504 identifies the one or more potential services. A selection of a service from among the one or more potential services is received at step 912. This may include, for example, the processor 120 of the electronic device 101 receiving a user input indicating that the user wants to subscribe to one of the one or more offered services. The selected service can be used as input in step 702 of the method 700 described above.

As described above, the specified service or the one or more potential services offered to the user 402 can vary depending on the circumstances. In some cases, the specified service or the one or more potential services can include at least one of: a decrease in network latency associated with communication over a cellular network, an increase in network bandwidth associated with communication over the cellular network, a guarantee of specified network latency associated with a particular application executed by the electronic device, a guarantee of specified network bandwidth associated with the particular application executed by the electronic device, or an addition of a roaming feature to the service plan. Depending on the implementation, a change to a user's service plan may be permanent or temporary, such as when a temporary change results in reverting back to the user's original service plan after a specified event has ended or after a specified time period has elapsed. If a subscription is temporary, a subsequent offer can be made to the user 402 to extend the temporary service subscription or to make the service subscription permanent.

Although FIGS. 7 through 9 illustrate examples of methods for mobile plan add-on, various changes may be made to FIGS. 7 through 9. For example, while shown as a series of steps, various steps in each figure may overlap, occur in parallel, occur in a different order, or occur any number of times (including zero times). Also, while FIGS. 8 and 9 illustrate two examples of how a specified service may be identified, the specified service may be identified in any other suitable manner.

It should be noted that the functions shown in or described with respect to FIGS. 2 through 9 can be implemented in an electronic device 101 or other device in any suitable manner. For example, in some embodiments, at least some of the functions shown in or described with respect to FIGS. 2 through 9 can be implemented or supported using one or more software applications or other software instructions that are executed by the processor 120 of the electronic device 101 or other device. In other embodiments, at least some of the functions shown in or described with respect to FIGS. 2 through 9 can be implemented or supported using dedicated hardware components. In general, the functions shown in or described with respect to FIGS. 2 through 9 can be performed using any suitable hardware or any suitable combination of hardware and software/firmware instructions. Also, the functions shown in or described with respect to FIGS. 2 through 9 can be performed using any number of devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, input identifying a specified service offered by a mobile network operator that is not currently part of a service plan associated with the electronic device;
generating, using the at least one processing device, a subscription message for the mobile network operator, the subscription message requesting the specified service from the mobile network operator;
initiating, using the at least one processing device, transmission of the subscription message to the mobile network operator; and
obtaining, using the at least one processing device, a response to the subscription message, the response indicating that the electronic device has been subscribed to the specified service.

2. The method of claim 1, wherein obtaining the input identifying the specified service comprises identifying, using the at least one processing device, the mobile network operator and the specified service based on an optical code.

3. The method of claim 2, further comprising one of:
when the mobile network operator is associated with a user account associated with a user of the electronic device, the subscription message causes the mobile network operator to associate the specified service with the user account; or
when the mobile network operator is not associated with the user account, the method further comprises receiving an electronic subscriber identity module (eSIM) from the mobile network operator, the eSIM enabling the electronic device to receive the specified service from the mobile network operator.

4. The method of claim 2, wherein the optical code comprises a QR code associated with an event.

5. The method of claim 1, wherein obtaining the input identifying the specified service comprises:
obtaining, using the at least one processing device, a push notification from the mobile network operator, the push notification offering one or more subscriptions to one or more services offered by the mobile network operator that are not currently part of the service plan associated with the electronic device; and
receiving, using the at least one processing device, an identification of the specified service from among the one or more services from a user.

6. The method of claim 5, further comprising, after receiving the push notification and before receiving the identification of the specified service:
initiating, using the at least one processing device, transmission of a request for information to the mobile network operator;
obtaining, using the at least one processing device, a response to the request for information containing information associated with the one or more services; and
initiating, using the at least one processing device, display of at least some of the information associated with the one or more services.

7. The method of claim 6, further comprising, after initiating transmission of the subscription message and before obtaining the response to the subscription message:
receiving, from the mobile network operator, a redirect to a web portal associated with the specified service;
initiating, using the at least one processing device, display of a webpage associated with the web portal; and
allowing, using the at least one processing device, the user to add the specified service to the service plan.

8. The method of claim 5, wherein the one or more subscriptions to the one or more services are identified using a machine learning model.

9. The method of claim 1, wherein the one or more services comprise at least one of:
a decrease in network latency associated with communication over a cellular network;
an increase in network bandwidth associated with communication over the cellular network;
a guarantee of specified network latency associated with a particular application executed by the electronic device;
a guarantee of specified network bandwidth associated with the particular application executed by the electronic device; or
an addition of a roaming feature to the service plan.

10. An electronic device comprising:
at least one processing device configured to:
obtain input identifying a specified service offered by a mobile network operator that is not currently part of a service plan associated with the electronic device;
generate a subscription message for the mobile network operator, the subscription message requesting the specified service from the mobile network operator;
initiate transmission of the subscription message to the mobile network operator; and
obtain a response to the subscription message, the response indicating that the electronic device has been subscribed to the specified service.

11. The electronic device of claim 10, wherein, to obtain the input, the at least one processing device is configured to identify the mobile network operator and the specified service based on an optical code.

12. The electronic device of claim 11, wherein:
when the mobile network operator is associated with a user account associated with a user of the electronic device, the subscription message causes the mobile network operator to associate the specified service with the user account; or
when the mobile network operator is not associated with the user account, the at least one processing device is further configured to receive an electronic subscriber identity module (eSIM) from the mobile network operator, the eSIM enabling the electronic device to receive the specified service from the mobile network operator.

13. The electronic device of claim 10, wherein, to obtain the input, the at least one processing device is configured to:
obtain a push notification from the mobile network operator, the push notification offering one or more subscriptions to one or more services offered by the mobile network operator that are not currently part of the service plan associated with the electronic device; and
receive an identification of the specified service from among the one or more services from a user.

14. The electronic device of claim 13, wherein the at least one processing device is further configured, after receiving the push notification and before receiving the identification of the specified service, to:
initiate transmission of a request for information to the mobile network operator;
obtain a response to the request for information containing information associated with the one or more services; and
initiate display of at least some of the information associated with the one or more services.

15. The electronic device of claim 14, wherein the at least one processing device is further configured, after initiating transmission of the subscription message and before obtaining the response to the subscription message, to:
receive, from the mobile network operator, a redirect to a web portal associated with the specified service;
initiate display of a webpage associated with the web portal; and
allow the user to add the specified service to the service plan.

16. The electronic device of claim 10, wherein the one or more services comprise at least one of:
a decrease in network latency associated with communication over a cellular network;
an increase in network bandwidth associated with communication over the cellular network;
a guarantee of specified network latency associated with a particular application executed by the electronic device;
a guarantee of specified network bandwidth associated with the particular application executed by the electronic device; or
an addition of a roaming feature to the service plan.

17. A non-transitory machine-readable medium containing instructions that when executed cause at least one processor of an electronic device to:
obtain input identifying a specified service offered by a mobile network operator that is not currently part of a service plan associated with the electronic device;
generate a subscription message for the mobile network operator, the subscription message requesting the specified service from the mobile network operator;
initiate transmission of the subscription message to the mobile network operator; and
obtain a response to the subscription message, the response indicating that the electronic device has been subscribed to the specified service.

18. The non-transitory machine-readable medium of claim 17, wherein the instructions that when executed cause at least one processor to obtain the input comprise:
instructions that when executed cause the at least one processor to identify the mobile network operator and the specified service based on an optical code.

19. The non-transitory machine-readable medium of claim 17, wherein the instructions that when executed cause at least one processor to obtain the input comprise:
instructions that when executed cause the at least one processor to:
obtain a push notification from the mobile network operator, the push notification offering one or more subscriptions to one or more services offered by the mobile network operator that are not currently part of the service plan associated with the electronic device; and
receive an identification of the specified service from among the one or more services from a user.

20. The non-transitory machine-readable medium of claim 17, wherein the one or more services comprise at least one of:
a decrease in network latency associated with communication over a cellular network;
an increase in network bandwidth associated with communication over the cellular network;
a guarantee of specified network latency associated with a particular application executed by the electronic device;
a guarantee of specified network bandwidth associated with the particular application executed by the electronic device; or
an addition of a roaming feature to the service plan.
